(19) United States
(12) Patent Application Publication
(10) Pub. No.: US 2014/0282205 A1
(43) Pub. Date: Sep. 18, 2014

(54) APPARATUS, SYSTEM AND METHOD FOR ELECTRONIC BOOK READING

(71) Applicants: Eugene Teplitsky, Great Falls, VA (US); Alisa Gusakova, Great Falls, VA (US)

(72) Inventors: Eugene Teplitsky, Great Falls, VA (US); Alisa Gusakova, Great Falls, VA (US)

(21) Appl. No.: 14/211,453

(22) Filed: Mar. 14, 2014

Related U.S. Application Data
(60) Provisional application No. 61/783,030, filed on Mar. 14, 2013.

(51) Int. Cl. G06F 3/0483

(52) U.S. Cl. CPC G06F 3/0483
USPC 715/776

(57) ABSTRACT

An electronic book reader and a method and computer program product for displaying an electronic hook provide the display of dynamic text. An electronic book reader may comprise a visual display, a processor configured to execute program instructions, a memory storing the program instructions to be executed by the processor, program instructions to be executed by the processor, and at least one content piece comprising a plurality of text, the text including at least one item of information for controlling dynamic display of text, wherein the program instructions are configured to perform, when executed by the processor, evaluating the at least one item of information for controlling dynamic display of text, and displaying, on the visual display, text based on the evaluation of the at least one item of information for controlling dynamic display of text.

### FIELD OF THE INVENTION

The present invention is directed to an electronic book reader, an electronic book reading system, and front and back end systems and methods for executing dynamic text in electronic book reading. In particular, the reader, system and method may include a display, at least one microprocessor that visually executes one of a plurality of book data to the display, at least one storage element that stores the plurality of hook data, and a plurality of modes executable by the at least one microprocessor. The system and method of the invention may further include storing a plurality of electronic book data and visually outputting the electronic book data with dynamic text to a display. The system and method of the invention may further include a back end process for authors, publishers, and/or advertisers that manages the revenue share.

### BACKGROUND OF THE INVENTION

Electronic book readers, also referred to as e-book devices or e-readers, are electronic devices that are designed primarily for allowing users to download and digitally view content such as books, magazines, and periodicals. Such devices may be dedicated e-book readers, or may be applications for use on tablets, laptop computers, but all typically provide portability, improved readability even in bright light, and long battery life. Some e-readers present content in black and white, while others present color content.

E-book readers allow for a user to obtain numerous content pieces, and make those content pieces mobile without having to carry multiple books. In such instances, a large number of books may be downloaded to the electronic book reader for ultimate reading by the user, wherein the downloaded books are thus mobile with the mobile user. However, there are usually charges for each content piece downloaded to the electronic book reader. While some content may be available for free to users, this content typically comes with banner ads. The banner ads may be interactive, i.e., if selected, the user will be directed to a website or application that is the subject of the advertisement.

There is a need in the art to provide content free of charge to the user, while still compensating the author of the content.

### SUMMARY OF THE INVENTION

The present invention is directed to electronic book readers providing dynamic text, the systems supporting the electronic book readers, and the methods and systems that occur on the back-end for the content authors, publishers, and advertisers. While the discussion herein is directed to electronic book readers, it is contemplated that the electronic book reader may be any network-enabled device that provides content to users electronically where the content incorporates dynamic text. In particular, the network enabled device may be any suitable device that is operatively connected to a network. The network may include the internet, intranet or private or public close group peer to peer or broadcast network, wireless network, analog network, digital network, or combinations thereof. In one embodiment, the network enabled device may include one or more of mobile device, Personal Digital Assistant, smart phone, feature phone, smart book, tablet, laptop, noteBook, net book, and the like.

An electronic book reader may comprise a visual display, a processor configured to execute program instructions, a memory storing the program instructions to be executed by the processor, program instructions to be executed by the processor, and at least one content piece comprising a plurality of text, the text including at least one item of information for controlling dynamic display of text, wherein the program instructions are configured to perform, when executed by the processor, evaluating the at least one item of information for controlling dynamic display of text, and displaying, on the visual display, text based on the evaluation of the at least one item of information for controlling dynamic display of text.

The program instructions may further perform continuously or periodically re-evaluating the at least one item of information for controlling dynamic display of text. The information for controlling dynamic display of text may comprise at least one of a time-based condition or an action-based trigger. The time-based condition may comprise at least one of a start date, an end date, a start time, an end time, a start moon phase, an end moon phase, a start weekday, or an end weekday. The action-based condition may comprise at least one of a view page number, a completed survey/quiz, or a completed scavenger hunt. At least some of the text that is displayed based on the evaluation of the at least one item of information for controlling dynamic display of text may be advertising content or sponsored content.

A method for displaying an electronic book in a system comprising a visual display, a processor configured to execute program instructions, a memory storing the program instructions to be executed by the processor, and program instructions to be executed by the processor and configured to perform, when executed by the processor receiving at least one content piece comprising a plurality of text, the text including at least one item of information for controlling dynamic display of text, evaluating the at least one item of information for controlling dynamic display of text, and displaying, on the visual display, text based on the evaluation of the at least one item of information for controlling dynamic display of text.

A computer program product for displaying an electronic book, the computer program product comprising a non-transitory computer readable medium storing program instructions to be executed by a processor configured to perform, when executed by the processor receiving at least one content piece comprising a plurality of text, the text including at least one item of information for controlling dynamic display of text, evaluating the at least one item of information for controlling dynamic display of text, and displaying, on a visual display, text based on the evaluation of the at least one item of information for controlling dynamic display of text.

An apparatus for generating content for an electronic book reader may comprise a visual display, a user input device, a processor configured to execute program instructions, a memory storing the program instructions to be executed by the processor, program instructions to be executed by the processor and wherein the program instructions are configured to perform, when executed by the processor receiving at least one content piece comprising a plurality of text, receiving, at the user input device, an indication of at least one item of information for controlling dynamic display of text specifying text that is to be displayed based on evaluation of the at least one item of information, and an indication of a location in the plurality of text, embedding the indicated at least one item of information for controlling dynamic display of text in the plurality to text at the indicated location.

### BRIEF DESCRIPTION OF THE DRAWINGS

FIG. 1 is an exemplary block diagram of the overall system.

FIG. 2 is an exemplary Bookshelves screen for a web-browser based implementation of Whampa Reader.

FIG. 3 is an exemplary Bookshelves screen for an Android app based implementation of Whampa Reader.

FIG. 4 is an exemplary reading screen for a web-browser based implementation of Whampa Reader.

FIG. 5 is an exemplary reading screen for an Android app based implementation of Whampa Reader.

FIG. 6 is an exemplary screen showing a Serial Subscriptions tab in Whampa Reader.

FIG. 7 is an exemplary Fiction & Literature screen in Whampa Reader.

FIG. 8 is an exemplary Fiction & Literature screen in Whampa Reader.

FIG. 9 is an exemplary flow diagram of a process of generating an eBook including dynamic text.

FIG. 10 is an exemplary flow diagram of a process of Dynamic Text creation.

FIG. 11 is an exemplary block diagram of a computing device in which one or more modules of the Whampa system may be implemented.

### DETAILED DESCRIPTION OF THE INVENTION

The present invention is directed to an electronic book reader that that provides a reading interface, a content catalog, a content purchase module, an advertisement module, a user entertainment module, and other modules, where the content includes dynamic text. The present invention encompasses the front end of the electronic book reader, as well as the back end.

The dynamic text contemplated by the inventors is viewable by the user while reading content on the electronic book reader and, as described in more detail below, has a back end process that is driven/managed by the content author, publisher, and advertisers. In one embodiment, the dynamic text feature may be based on a plurality of parameters including, but not limited to, date, time, ambient light, number of readthroughs, presence of other books in the user's content catalog, and combinations thereof.

The front end may be employed in a browser setting, or in a non-browser setting, such as an app on an operating system such as android, 105, windows 8, and the like. In the non-browser setting, the electronic book reader may include a catalog of user's content. The catalog may be imported from a file system or the internet. The catalog may also enable content export to a file or content share. In addition, catalog may be used to rate/review books.

In addition, in the non-browser setting, the electronic book reader may include a catalog of market content or content purchase module. In one embodiment, the content purchase module may include a reader affinity rating that indicates how likely the user is to enjoy the content based on self-reported reviews/ratings of previous content.

The reading interface may include a plurality of features including, but not limited to, page flipping, display settings, searching, bookmarking, annotation, rating of finished books, and combinations thereof. In addition, the electronic book reader may have a feature that allows various narration modes including audio reading. In one embodiment, the audio feature may enable a user to select various narrators.

The electronic hook reader may also provide in-book advertising for free books via conventional methods, i.e., banner advertisements. This feature is able to be turned on and off by the user.

The electronic hook reader may include quizzes, surveys, game modes, and combinations thereof. In addition, the electronic book reader may include a subscription feature to manage serials, receive regular downloads of updates, pay for paid subscriptions, and combinations thereof.

In addition, in a non-browser setting, the electronic book reader may include social tools for inviting/managing friends, creating a community profile, participating in an in-book chat, being notified/reminded of author events, and the like. In addition, the electronic book reader may allow for participation in reader forums and chat rooms, may manage credit inventory, and may allow for gifting. The internet connection settings (e.g., update interval, privacy settings) may be modifiable by the user with the electronic book reader.

On the back end, with respect to users, the following are contemplated:
a catalog of market content (and a purchase module for the same)
a content catalog of the user's books (importing books from file system or Internet, exporting books to a file, sharing with friends)
ability to filter site content based on user's age, to hide inappropriate content
social tools (inviting/managing friends, creating a community profile)
managing and sharing hook reviews and ratings
reader forums and chat rooms
integration with users social profiles to help recommend books, authors, and friends based on book preferences
ability to write detailed reviews for books that readers have completed and rated
purchasing credits and managing credit inventory, gifting, and managing payment methods
the ability for a user to become a beta reader or book reviewer (and view and manage incoming projects)
privacy settings

On the back end for authors, the following are contemplated:
Composition tools (auks-correct, choosing a style guide, proofing tools)
Collaboration modes
Dynamic text shortcodes
Advertising shortcodes
Quiz, survey, and game shortcodes (walkthrough to making a “choose your own adventure” book, and the like)
Listing and searching for collaborators
Inviting collaborators to join your project, setting ownership parameters
Listing and searching for project in need of collaborators
Placing your project on the market to attract collaborators
Listing and searching for talent (beta readers, editors, proofreaders, illustrators, audio artists, trailer designers, translators, marketing help)
Listing and searching for literary universes
Creating and managing literary universes
Managing contracts, resolving disputes
Managing royalty payouts, payment preferences, tax information
Viewing and responding to book reviews
Setting up and hosting in-book author events (signings, chats, etc.)
Managing alert preferences
Managing author account (contact info, avatar, bio, social links)
Live feed of random sentences from books people are writing (can be disabled in privacy settings)
Exporting books to other non-Whampa formats (PDF, EPUB, Mobi, WIT)
Serial management, adding updates, receiving payment for monthly subscription fees

On the back end for advertisers, the following are contemplated:
Setting up staff accounts (acquisitions, marketing, accounting, management)
Listing and searching for books ready to receive advertising based on criteria
Making direct offers and responding to counteroffers
Using the bidding interface
Filling in advertising shortcode text variations
Creating banner ads
Managing ad inventory
Managing ad budgets, purchasing advertising credit
Managing advertiser account (contact info, avatar, company bio, social links)

On the hack end for publishers, the following are contemplated:
Setting up staff accounts (legal, acquisitions, production, marketing, accounting, management)
Managing contracts, countersigning, resolving disputes
Listing and searching for books looking for a publisher based on criteria
Making direct offers and responding to counteroffers
Setting up and managing Publisher's style guides or public style guides
Managing inventory of properties in production (uploading covers, managing/uploading interiors, assigning proofreaders, editors, quality control, setting release dates)
Managing inventory of produced titles (managing marketing materials)
Managing and distributing galley copies to book reviewers based on certain criteria (number of books reviewed, age group, gender, Reader Affinity rating)

On the back end for talent, the following are contemplated:
Listing and searching for projects in need of their particular type of talent
Setting up your account with talent details
Managing payouts, payment preferences, tax information
Delivering digital goods and services

The system and method of the present invention and specific embodiments described above may be implemented, for example, in hardware, one or more computer programs tangibly stored on one or more computer-readable media, firmware, or any combination thereof. Similarly, the embodiments described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device.

The overall system includes a plurality of modules that implement various portions of the functionality, as shown in FIG. 1. Examples of such modules may include:

1. Whampa Reader 102—a digital eBook market and integrated reading environment accessible via the web browser and as native Android, iOS, and Windows Phone/RT 8 applications
2. Whampa Writer 104—a suite of e-publishing tools enabling authors to create, collaborate, market, and oversee all aspects of their publishing journey.

Each of these components may be implemented together as part of a unified network, or independently, such as a series of SAAS (Software as a Service) websites. The listed components will be described in more detail below:

Whampa Reader provides a reading and catalogue interface through which consumers can experience books, comics, textbooks, and other digital written materials in new and unexpected ways. It is not just a tool to display book content it's a social media network built around the literary likes and interests of its participants. A number of functions may be implemented within Whampa Reader. Examples of such functions are described below, using particular examples of types of content, such as a book. However, these are merely examples, the present invention contemplates any and all current and future types of content.

Whampa Reader may accept content files of various formats. However, in order to fully implement the described functions, content files utilizing a particular proprietary implementation of the EPUB3 standard format are accepted. Such a format, which may be termed WePub, may include support for standard EPUB3 features, with many additional features and tools at authors' disposal. WePub is designed to be easily exportable to EPUB3, whereby Whampa-proprietary features would gracefully degrade, resulting in a usable, compatible, and well-designed eBook file—no matter the reader software used.

Dynamic content—the book's content may change based on various factors, such as time of day, GPS location (including state of travel), amount of ambient light, presence of other books in your bookshelf, answers to a quiz in the book, your achievements, and so on. Authors can use simple logic to open and close portions of the content to create a dynamic, engaging experience. This can facilitate a completely new sort of book—one that evolves based on the user's lifestyle. For example:
Make a scary book even scarier when read at night or in the dark or on Halloween,
Play a “choose your own adventure” style game inside the fantasy book you're reading.
Be rewarded for subsequent read-throughs, or for purchasing several books in a series.

Engagement Features—titles may be equipped with several different kinds of engagement tools. Special sections of the book may contain multiple-choice, free-form, or multimedia (picture attachment from device camera to unlock a pattern-based barrier, audio attachment from device microphone) answer fields that can be submitted to participate in quizzes, surveys, etc. A certain number of correct answers may be required in order to proceed further in the book. Static quizzes with no dynamic features are managed right inside the reader, while dynamic quizzes (those that require reporting or interaction with the backend) are coordinated via online connection. For example:
Integrate real life engagement with in-book activities use pictures, sound, and video to unlock content.
Answer quizzes to ensure comprehension of content for a class assignment.
Submit your feedback about a book directly to the author—right from inside the book,

Book Fixes and Updates—all books have a built-in facility for reporting typographical, grammatical, and other errors to the author, and if the author accepts the fixes, the eagle-eyed reader receives a reward of credits and other bonuses. Updated manuscripts that are pushed out to the market are automatically distributed to readers, giving the user a choice of whether to accept the update or ignore it. This helps ensure that everyone is literally on the same page. For example:
Be rewarded for helping authors correct errors in their books,
Get updates when the author makes corrections to their manuscript,
Books become better and better when users are incentivized to help make them so.

Multimedia Features—books can be experienced not only as text, but also can include multiple audiobook tracks, background music soundtracks, and video narrations. All of these may be free, unlockable, or purchasable on a per-track or per-book basis. For example:
Read a book while listening to the same songs that inspired the author to write it.
Hear the author read their own book to you, or switch to a professionally narrated track.
Experience your cookbook with a video tutorial walking you through the steps of making a dish.

Bookmarks & Annotations—readers can easily add their comments to any portion of a book by simply selecting text. This feature also serves as a custom bookmark, to easily move to various portions of a title. Bookmarks & annotations are synchronized with your user account, and can be shared with other users reading the same book for collaborative annotating, or exported along with the book's metadata file. Each comment is linked to a specific user, so it's always possible to see who left a comment. For example:
Bookmark and comment on important parts of a story,
Share your annotations with other users and create a growing collaborative collection of annotations.
Export your book along with annotations and share as copies with other users.

In-Book Product Placement—as an additional method of monetizing books and helping counteract piracy, product placement can be transparently and unobtrusively placed into books, dynamically changing to reflect the top bidding advertiser at the time of book's download. All product ads are pull-based, requiring the user to click/touch a part of the text to call up the advertising content in a dialogue box. Achievements may be earned to reward users' ad-watching behavior. The winning bidder products featured in a book will not change as long as the reader does not leave the book alone for a set period of time. For example:
Read about the protagonist driving that cool car then learn about the actual car behind the story.
Earn rewards for experiencing sponsored content and sharing it virally.
Books are monetized even if they are shared with friends or uploaded to file sharing networks.

Multiple Pricing Models—the typical way a reader will pay for books is on a per-page basis—the more you read, the more you pay. But it is also possible to purchase a book outright in full, thus being able to avoid having to download pages while reading. It possible to easily filter books in the catalogue to only show free or ad-supported titles. Our preferred model is Pay-Per-Page, because it is fair to users and authors, disruptive, to competitors such as Amazon.com, who rely on books being paid in full to justify paying for the 3 g Whispersync data transfer to reading devices. In certain cases (such as bundles), it is also possible to use a name-your-price scheme, where readers type in their own price, and if they pay more than the average amount, they receive an extra book or bonus. For example:
Avoid the risk of paying for a book you might hate by paying only for the pages you've already read.
Load your offline reader device with multiple books and avoid the need to download by buying in full.
Pay with money or with site credits that you purchase or earn through achievements and contests.

Serialized Books &. Periodicals—some titles may be offered in a serialized subscription format. In this case, subscribed readers are notified when updates are available, and may have them downloaded to their Whampa Reader or sent via email (like, for example, via Send to Kindle). Serials are a great way to experience a story that would be otherwise too long and complex for a standalone novel. Periodicals are great for news updates from your favorite journalists, bloggers, and publications. Serials and Periodicals may be monetized the same way as any other property. For example:
Purchase a weekly, monthly, or quarterly subscription to a serialized story for unlimited updates.
Purchase the entire story outright in full, and receive all future installments free.
Pay nothing upfront and simply pay for each installment on a per-page or per-installment basis.

Subscriptions—some authors, publishers, literary universes, series, and book bundles may be offered on a subscription basis, not unlike a serial, but more far-reaching. A user pays a flat monthly, quarterly, or yearly fee, and gets unlimited access to all of the current, past, and future books that are include in the subscription. For example:
Sign up to receive books from a group of your favorite authors who have joined forced.
Follow your favorite literary universe for a fixed fiat rate.
Automatically receive all books published by your favorite publishing house.

Robust Catalogue Searches—finding your favorite new book is easy with our robust catalogue searching system. Search and filter by genres, publication date, book prices (including free), mood tags (“gloomy”, “excited”, “happy”, etc.), concept tags (“vampires”, “ghosts”, “police”, etc.), star ratings, number of active readers, affinity rating; Hide books you've already read or have in your shelves, show books that your friends like, and more. Pre-set search listings include: Recommended for You (books chosen by whatever algorithm predicts what you might like), Site-Wide Bestsellers (a random selection of the top 100 books), Best In Show (a random selection of 100 books that have received the best review ratings and in the greatest number), Category of the Day (a random category chooser that rotates between different categories each day, showing a random selection of the top rated and bestselling books in that category), Freebies of the Day (random selection of top-rated, most-downloaded books that are 100% free to read right now), From Your Slush Pile (top rated, bestselling books that you've added to your shelves but haven't read yet), Staff Favorites (a random selection of books liked by Whampa staff), Friends Favorites (a random selection of books liked by people on your friends list), But Wait, There's More! (sequels to books you've read and liked). For example:
Use many unique ways of searching to narrow down the book you want.
Use social factors, such as books your friends like, to find a book to read.
Find a book that fits your mood with mood tags,

Mood Tags—users and books can have a mood tag. This represents how a user is feeling now, and the mood that's expressed through a book. This data is used to match users with books that fit their mood (not necessarily a 1-1 match). Books' content can also change according to users' present mood tags. Users can and should get creative with their mood tags to see what new surprises might lie in store inside their dynamic Whampa books. For example:
If you're feeling “sad”, your book might try to cheer you up.
If you're a “lonely” housewife, you might get more suggestions for womens' erotica novels.
Unlock previously hidden scenes and content depending on your mood.

Importing to Whampa Reader—readers can bring their existing books into their Whampa bookshelves by importing one of several supported file formats. Imported books cannot be shared with other users and will not be transferred when sharing the bookshelves which contain them. The mobile reader application can open WePub, EPUB, and other eBook files natively. It can also be used to open locally stored files of various non-eBook formats, which would be sent to a web conversion service like Google Does for conversion to PDF for maximum compatibility and maximum market penetration through replacing the need for having the Kindle application installed as a PDF reader, for instance. For example:
Import books in EPUB, Mobi, PDF, Doc, Doex, FB2, RTF, TXT, ODT, and other formats.
Keep your whole collection of books in one place, synchronizing via your Whampa account.
Open documents with your phone or tablet right inside the Whampa Reader.

Exporting from Whampa Reader—all Whampa books can be exported by readers to a special metadata, format that enables users to easily share them on file sharing networks, personal websites, email, etc. You can specify what data you'd like to include with the file, such as your annotations. When the files are downloaded, the Whampa Reader automatically downloads any additional required data to make the books work and the new user will pay per page from their account, unless they choose to purchase in full. There is no restriction for using the same book on multiple machines, accounts, etc. Each user who opens a book leaves their unique ID on it (or, rather, the book's unique ID gets linked to their account), and then passing it on to someone else leaves their ID. This creates a “sharing trail”, so the system can track the whole chain of users who have passed this book on. Users at the root of the longest sharing trail can be rewarded with achievements and other concessions to encourage sharing. For example:
Possible to easily exchange books with your friends.
Upload books to file sharing networks, websites, forums, etc.
No worries about piracy—Whampa Reader will take care of payments regardless of where you share.

Whampa Writer provides the capability to author and produce content to be presented by Whampa Reader. Whampa Writer provides advantages such as collaboration, transparency, and flexibility in production and marketing. A number of functions may be implemented within Whampa Writer. Examples of such functions are described below, using particular examples of types of content, such as a book. However, these are merely examples, the present invention contemplates any and all current and future types of content.

Whampa Reader may generate content files of various formats. However, in order to fully implement the described functions, content files utilizing a WePub format may be generated.

Multiple Book Contributors—authors and publishers can invite multiple users into any book project and assign various roles to them. They can specify how compensation will work for each user (a fixed fee, a percentage of sales, or a more complex contract), as well as voting privileges on major project decisions (for example, to help co-authors democratically decide on various business actions). Additional project participants can be either invited via email, from your friends list, or via the Whampa Market. For example:
Hire an illustrator to make your cover and compensate them 10% of the first 100,000 copies sold.
Invite your two co-authors and set up a 50/25/25 split in royalties and voting rights.
A publisher might invite ghost writers, marketers, editors, and other talents into a book project.

Collaborative Composition Tools—authors can create content using a suite of composition tools for writing hooks from scratch or editing existing works, similar to a fully-featured word processor. Multiple users can work on the same document and see each other's updates happening in real time, tagged by the username of the person making the change. The entire history of revisions is tracked, to enable authors to roll back changes and create new revisions. For example:
Join your co-authors in working on the same chapter at the same time.
Import EPUBs from other markets into your editor and continue where you left off.
Follow your team mates' work via the change tracker to ensure everyone is on the same page.

Mobile and Desktop Writer Applications—a limited set of features of the writing interface are implemented as part of a mobile application for Android, iOS, and Windows Phone 8 platforms. This allows authors to work on their books on the go. MI work is synchronized with the web, so they can continue working where they left off, regardless of what device they switch to. A fully-fledged desktop publishing variant for Windows, Mac, and Linux will also be available. For example:
Write your future bestselling novel during your daily train trip to work or school.
Easily shift gears between working on your phone or tablet and working on your desktop.
Enjoy many of the same features as the web-based composition tool, on the go.

eBook Formatting Tools—authors are able to easily format their eBooks to ensure they look clean, professional, and easy to read, A wide selection of heading font styles, drop caps, neurons, divider images, and more is supplied to users, who can easy plug them into their manuscript with a couple of clicks. Images, embedded video, audio, and more can be inserted via a WYSIWYG (“What You See Is What You Get”) editor interface. Automated wizards are available to walk users through creating more advanced sections, such as quizzes, dynamic portions of the book, product placement zones, etc. For example:
Make your book look great without knowing HTML, CSS, or familiarity with eBook formatting.
Easily implement the advanced dynamic content and multimedia features with several clicks.
Easily attach product placement zones to your manuscript as your write it.

Multiple Project Types—it's not just eBooks that are supported, but also screenplays, graphic novels, magazines, and other content types. Each type enables the relevant editing tools that make it easy for authors to arrange content with as much automation as possible. For example:
Create screenplays for competitions under the auspices of Whampa Film.
Create graphic novels out of images that get arranged automatically across one of many grid layouts.
Easily duplicate a project and change its type to create other editions of the same work.

In-Book Advertising Features—authors may easily implement product placement zones around parts of text in their story, as well as add sponsored book sections at the start, end, or within their manuscript, to which other authors' bidding sponsored ads may be placed. This helps ensure a secondary revenue stream for authors, encouraging successful ones to eventually move to a totally free model. Several Hollywood-style product placement modes are available, such as Visual (seen in the background), Verbal (mentioned by a character), and Hands-On (actively used by a character) placements. We want to see advertising revenue replace author advances in the industry. Advertising content can be managed (for complex situations requiring author's approval) or unmanaged (for simple cases where a word substitution will suffice). For authors who do not want to or are not able to find the time to manage the advertising within their books, it is possible to automate the process and place ad content on certain keywords and product names. Authors can also hire an advertising professional from the Whampa Market, who can manage the ads inside their books on a commission or % of royalty basis. For example:
Turn products used in your story into product placement zones, informing and engaging users.
Add sponsored blocks to promote other books (alternatively, your own books) inside a book.
Monetize a recipe book by advertising brand-name ingredients.

Manual Overrides—all manner of in-book features concerning dynamic text, advertising zones, engagement features, etc. can be manually inserted into the book using Wordpress-style Shortcodes (for example: [shortcode param=“value”]content[/shortcode]). User-friendly guides walk hands-on authors through various features, such as making a ‘choose your own adventure’ book, and other projects. For users who prefer not to use shortcodes, the same functionality can be integrated into the text using MS Office-style buttons. For example;
Go beyond the limitations of interface buttons and manually insert complicated processes into a book,
Easily learn to create interactive book content through the built-in help.
Create Whampa-ready content outside of the Whampa reader, or using third-party tools.

importing and Exporting Books—authors may import manuscripts in the same formats as Whampa Reader supports. Imported manuscripts are automatically broken down into their base components and arranged in the editing interface. Once they've edited a manuscript to their liking, authors may export it to other eBook formats, such as EPUB and Mobi, in case they wish to load them into other markets. For example:
Create a feature-rich version of your book, and have it degrade gracefully for Amazon and others.
Load the manuscript you currently use on other markets and update it to reflect all the new features.
Revitalize your old collection of published works with a brand new approach, regardless the format.

Production Management—authors can easily manage their books, upload covers, manage/upload new interiors, assign proofreaders, editors, quality control, etc. and set release dates (including pre-orders), pricing parameters, ad preferences, and other settings for each book. For published books, authors can monitor royalties, reviews, and active readership in real time, for specific time periods and market segments. For example:
See how many people are actually reading your book RIGHT NOW, and what their demographics are.
Set up a book for pre-order and earn a ranking even before release, with a burst of revenue at release.
Easily integrate with the Whampa Market to hire talent on the fly.

Self-Serve Advertising—authors can book sponsored placement for their titles on the site (in a special “promoted” block within each individual category, and in users' recommended lists). A real-time bidding system determines whose books show up in various areas. All sponsored products are specifically flagged as sponsored content, for the sake of transparency. For example:
Target as broad or as specific a demographic as you need, as well as specific types of placements.
Declare your bid and adjust it up/down in real time to match the max bidder.
Set up automatic bidding up to a pre-configured upper limit.

Whampa Market facilitates the exchange of services, for money or credits, or for free. Whampa Market provides a catalogue of other users with specific talents who are available, or projects looking for help, based on the criteria that is relevant to each search, A number of functions may be implemented within Whampa Market. Examples of such functions are described below, using particular examples of types of content, such as a book. However, these are merely examples, the present invention contemplates any and all current and future types of content.

Advertising Marketplace—each book with advertising features implemented is automatically listed in the Advertising Marketplace, a catalogue of books through which advertisers, publishers, and authors may browse and select those that fit their advertising needs and ROI projections. This portion of the marketplace is sortable by site ranking, reviews, etc. to help advertisers put their money behind titles that have a good chance of attracting clicks and eyeballs. Advertisers can easily view their budgets for various campaigns and pause/stop/delete campaigns and adjust budgets from one interface. Ads are sold on a CPC (cost per click) basis. For example:
Advertisers can invest their budget in a bestseller to further boost their visibility.
Easy searching and filtering to allow advertisers to back the cream of the crop.
Authors can bid to promote their book inside a specific book's sponsored book blocks.

Product Placement Process—once a project is picked, the advertiser can see individual product placement zones inside that project that they can submit proposals to. When a placement proposal is sent (which is just an array matching a pre-configured advertisement with a placement, and a custom wording that will replace the generic text of that placement), the author (depending on who is responsible for advertisement) must accept or reject the placement. Once it is accepted, the advertiser may bid on the placement against other advertisers, or offer a one-tune buyout for a particular time period, or even for the life of the product. Whoever is the top bidder (or has bought out the project) will be displayed in the selected placements when the book is downloaded, and downloaded copies won't change unless they have not been opened for a certain period of time, to help avoid confusion on the part of the readers. It is also possible to utilize a simplified product placement process that does not need to be hand-matched to the book and can be applied across the board automatically for all compatible projects. For example:
Submit your proposal for specific zones, tailor-made to fit the manuscript,
Use simplified product placement process to place your ad into multiple books with no back-and-forth.
Use real-time bidding to ensure your ads are being displayed as top bidder.

### I. Whampa Reader Examples

Examples of the operation of Whampa Reader according to an Embodiment of the Present Invention are described below. The examples shown include a web-browser based implementation and an Android app based implementation. However, these are merely examples, the present invention contemplates implementation on any current or future hardware or software platform.

A typical destination from the main screen of the Whampa Reader is the Bookshelves screen of the Library. An exemplary Bookshelves screen 200 for web-browser based implementation is shown in FIG. 2, while an exemplary Bookshelves screen 300 for an Android app based implementation is shown in FIG. 3. This screen displays all titles that the user owns and has imported into Whampa Reader. An All tab may display all content, such as eBooks, audio books, videos, samples, and serial subscriptions. Selecting another tab will narrow the selection to only that type of file.

Files that have not yet been opened in Whampa. Reader are indicated, such as by having their titles underlined in blue. Serials that have been previously opened that have since been updated with new episodes are indicated, such as by having their titles underlined in red.

By default the content will be sorted in order of most recently downloaded 202, with options to change number per page and reorder by title or author 202, 204.

Additional controls may include a Search function 302, which can be used to search by title, author, genre, and metadata information, such as back-cover description. The Search function 302 will automatically search all of these fields; the Advanced Search option can be used to narrow the search.

To open a title, double click its thumbnail in the listing.

### A. Importing Titles

EBooks, audio books, and video can be imported into Whampa Reader either by transferring the files into the library directly, or using the Import option in the library. Files may be transferred directly into the appropriate folder, or files may be imported using the appropriate menu command from within the browser or app.

### B. Navigating Within a Book

An exemplary reading screen 400 for web-browser based implementation is shown in FIG. 4, while an exemplary reading screen 500 for an Android app based implementation is shown in FIG. 5. Navigation commands such as move back or forward one page are provided by tapping the edges of the pages, or forward and back arrows may be shown. Pressing and holding moves back or forward to the previous or next chapter. On PC, Mac and Linux applications, and browser versions of Whampa Reader, the cursor keys can be used similarly, with left and right as back and forward. Holding shift while pressing left or right will move back or forward to the previous or next chapter or scene break.

A page and/or chapter counter 402, 502 may also be provided. Tapping and/or clicking either counter provides the capability to type over and skip to a specific page or chapter. Chapter breaks are built into the EPUB file itself by the publisher, and are not automatic. As such, not all eBooks will include chapter numbers.

### C. Subscriptions

Selection of Serial Subscriptions tab 206, shown in FIG. 2, or Serial Subscriptions tab 602, shown in FIG. 6, causes display of serial subscriptions saved in Whampa Reader. This includes any serials that are no longer subscribed to but have not been deleted. By default these will be sorted in order of most recently downloaded or updated, up to fifty per page, but in the top right are drop down boxes to change number per page and reorder by title or author.

Each title shown may include information such as a thumbnail, title, author, genre, date last updated, subscribed yes/no, ‘Update’ button next to each serial and info button. Serials that have not yet been opened in Whampa Reader may be indicated, such as by having their titles underlined in blue. Serials that have been previously opened that have since been updated with new episodes may be indicated, such as by having their titles underlined in red.

Click the thumbnail may open a serial. This may provide a full list of episodes and news posts. Again, by default these will be sorted in order of most recently downloaded, but the number per page may be changed and the may be reordered by title.

With auto-updates enabled, all serials that are subscribed to will automatically update when Whampa Reader is opened. For mobile devices, auto-update can be set to update subscriptions either every time Whampa Reader is opened, or only when connected to the internet via Wi-Fi. Alternatively, updates may be manually controlled, by providing buttons such as Update Subscribed and Update All. Update Subscribed will search for and download updates for all serials you have an active subscription for. Update All will search for and update all serials on Your Subscriptions page. Serials can be updated individually by clicking the Update button in the serial's listing.

Beside these options is a Search function, which can be used to search by title, author, genre, and metadata information, such as back-cover description. The Search function will automatically search all of these fields; the Advanced Search option may be used to narrow down the search.

Each serial lists whether or not the subscription is active. A button may be clicked to change the subscription status, A confirmation box, including payment entry fields, if necessary, may be displayed.

### D. Dynamic Text

Some books available on Whampa Reader may take advantage of the dynamic text feature. This feature provides the capability for the author to write alternative versions of words, sentences, paragraphs, or whole chapters. Some of these change automatically in reaction to day/night, seasons, etc., and some are unlocked versions of the book you select. By default, automatic dynamic text is enabled and appears normally, but setting can modify this to highlight dynamic text, or turn off automatic dynamic text entirely.

Alternative versions can be unlocked in a variety of ways. Sometimes they are available as soon as the book is opened, sometimes they are made available by reaching the last page, completing a quiz or survey, etc. Alternative versions may be selected when unlocked, upon opening a book, manually at any time, etc.

In a free, sponsored copy of a book, sponsored text behaves very similarly to automatic dynamic text to replace a small number of specific words (vehicles, store names).

Dynamic and sponsored text is described in more detail below.

### E. Quizzes and Surveys

Some eBooks, videos, and audio books may contain quizzes and/or surveys. These can be embedded into the text, but are more commonly found at the end of the book. Once answers have been entered, the quiz may be submitted to send the answers to Whampa and to display quiz results to the user. By default, Whampa Reader send results immediately, or if no Internet connection is available, stores the data until you are connected. For mobile devices, this can be changed.

Sometimes surveys or quizzes are purely for fun, sometimes they are part of a competition or similar. If there is a reward or draw, the user is entered automatically by submitting the completed survey or quiz, unless the author/publisher states otherwise.

Authors/publishers can respond to submitted surveys or quizzes, for example by email, such as to the email of the Whampa Reader, rather than the private email of the user.

### F. Scavenger Hunts and Puzzles

Another unique feature of Whampa Reader is scavenger hunting. And author or publisher can embed keywords or images into a hook, which can be collected by clicking on them. Scavenger hunts can be confined to a single book, or spread over several books by one or more authors. Progress in scavenger hunts can be seen in a user's profile, which may include information such as which books include items from the scavenger hunt, how many items are included, and how many the user has found, as well as any other information the author or publisher has revealed. When a scavenger hunt is completed, the completed hunt may be submitted to the author/publisher.

Sometimes scavenger hunts are purely for fun, sometimes they are part of a competition or similar. If there is a reward or draw, the user is entered automatically by submitting the completed scavenger hunt, unless the author/publisher states otherwise.

Authors/publishers can respond to submitted scavenger hunts, for example by email, such as to the email of the Whampa Reader, rather than the private email of the user,

### II. Whampa Writer Examples

Examples of the operation of Whampa Writer according to an Embodiment of the Present Invention are described below. The examples shown include a web-browser based implementation and an Android app based implementation. However, these are merely examples, the present invention contemplates implementation on any current or future hardware or software platform.

A. Creating an eBook

If a book is already in EPUB format, Whampa Writer can Upload and automatically converted the book to Whampa Reader's file format. Additional information may be required before the file can be published. Such information may include genre, maturity rating and author names, etc. For other file types, such as RTF, DOC, DOCX etc., one or more conversion tools are included in the reader. These conversion tools may be currently available open source conversion tools, or they may be custom or proprietary tools.

One of Whampa Reader's unique features is the ability to make sections of text within your eBook change depending on different factors. Automated dynamic text refers to changes that are automatic and happen without informing the reader, while alternative versions are optional versions, where the reader selects which version to read when they open the file.

An exemplary process 900 of generating an eBook including dynamic text is shown in FIG. 9. The process begins with step 902, in which a dynamic text profile is created, with its own rules and parameters. Thereafter, the book may be edited as it is to be viewed.

To create an automated dynamic text profile, in step 904, options for automatic display of various text versions must be set. Such options may include time-based options, which determine when the text will change, such as a start date, an end date, a start time, an end time, a start moon phase, an end moon phase, a start weekday, an end weekday, etc. These criteria may be applied individually, or in combinations, such as “meets all criteria”, “meets at least on criterion”, etc. There may also be multiple entries for each option, such as multiple start/end dates and time, etc.

For example, there may be option settings such as:

Start date 1^{st} June, end date 7^{th} June,

Start date 1^{st} July, end date 7^{th} July.

Start date 1^{st} August, end date 7^{th} August.

Start weekday Tuesday, end weekday Tuesday.

The result with “meets all criteria” is that the alternative text will appear on the first Tuesday of June, July and August, while the result with “meets some criteria” is that the alternative text will appear during the first week of June, July, and August, as well as every. Tuesday.

Examples of possible uses may include:
Include an ‘Easter egg’ short story that appears in the epilogue during the first full moon after midsummer's day.
Replace a couple of the vague, “barely glimpsed as he ran away” descriptions of monsters with gruesomely detailed ones if the book is being read late at night.
Rename a main character Bozo the Clown for one day as an April Fool's Joke.
Set the story in the current season, with amendments to clothing, surroundings etc. depending on whether it's summer or winter.

The options for text display in the automated dynamic text profile may include action-based “trigger” options, such as, view page number, completed survey/quiz, completed scavenger hunt, etc. These trigger options determine when an alternative version of the eBook will be “unlocked”, based on actions taken by the reader. For example, “view page number” means that the alternative version will be unlocked by the reader viewing that page of the book, e.g. reaching the last page will unlock an alternative version. “Completed survey/quiz” and “completed scavenger hunt” mean that, completing them can unlock an alternative version upon completion of the survey/quiz or scavenger hunt. Clicking the “add” button next to these options will open a window that lists all surveys, quizzes or scavenger hunts currently set up within your book, in alphabetical order of the name they were given in their own profile. Double click to select, and the quiz, survey or hunt's name will appear under the “completed survey/quiz”/“completed scavenger hunt” heading, to show that completion of this element is now a trigger for this alternative version. These trigger criteria may be applied individually, or in combinations, such as “meets all criteria”, “meets at least on criterion”, etc. There may also be multiple entries for each option, such as multiple start/end dates and time, etc.

For example, there may be trigger option settings such as:
View page number 220, complete survey (end survey),

The result with “meets all criteria” is that the alternative version will be unlocked when the reader has viewed page 220 (the last page of the story), and completed the survey at the end of the book, while the result with “meets some criteria” is that the alternative version will be unlocked when the reader has viewed page 22.0 (the last page of your story), OR completed the survey at the end of the hook.

Examples of possible uses may include:
Provide a bonus chapter for readers who complete a quiz or survey.
“Director's cut” for readers who have completed the book once often scenes that add characterization or backstory are cut for pacing reasons, etc. Someone re-reading may be interested in more detail.
Cross-over short story between a book and someone else's, as a reward for completing a scavenger hunt across both books.

Once a dynamic text profile has been set up, in step 906, the text manuscript of the eBook is edited. During editing of the manuscript, the manuscript can be viewed with other dynamic text visible or with other dynamic text hidden. For example, if there is an alternative version with extra chapters, and with automatic dynamic text set up to change the name of the main character's dog when the book is read at night, the change can be made to both the default version and alternative version. The text, including the default text, the alternative text, and the dynamic text, is input by typing, cutting and pasting, etc.

In step 908, quizzes, surveys, scavenger hunts, and the like, are created and embedded in the eBook. Quizzes, surveys, etc., are embeddable widgets that may be included in a hook to get feedback from your readers, run competitions, or just for fun. They can be placed anywhere in your book, although they are most commonly found at the very beginning or very end. When readers complete these quizzes or surveys, their responses are logged for review.

To create a new quiz, information such as the name of the quiz, the questions making up the quiz, the correct answers, other answers, etc., are entered in the appropriate fields and automatically formatted and displayed when the quiz is being taken. The location or locations in the eBook at which the quiz is to be made available to a reader is determined and links to the quiz are embedded at those locations. Creation of a new survey is similar, with information such as the name of the survey, survey questions, and survey answers, entered in the appropriate fields. A free text answer field may also be defined. This information is automatically formatted and displayed when the survey is being taken. The location or locations in the eBook at which the survey is to be made available to a reader is determined and links to the survey are embedded at those locations.

Both quizzes and surveys store responses the same way. Setting up an automated response will send an email to the email address the reader registered with Whampa when they submit a completed quiz or survey. This is typically used to send a thank you, or codes for discounted copies of your other books. A manual email may also be sent. The only difference in responses between a survey and a quiz, is that there may be two or more different automated responses for those who get the minimum score and those who don't, etc.

In step 910, the eBook may be linked to a Literary Universe, which may already exist or which may be created. Many books are part of a series, or are separate story told in the same world, with overlapping culture details or characters. Sometimes this is obvious, such as book four in a clearly marked series, but sometimes the novels might be in different genres or series. Usually, a literary universe is written by a single author, but again this is not always the case. The concept of literary universes is to make it easier for fans of a title to find more books connected to it.

A book's Official Universe comprises authorized books in the same world, written by one or more authors. An Official Universe can be set up by any author or publisher for one of their books, making them the owner of it, any they can then add other publishers or authors as moderators, if the universe has more than one contributor, or if both author and publisher want access. Depending on the universe's settings, other authors can request a book of theirs be included in the universe, or it may be invite-only.

A book's Open Universe is essentially a fan-fiction archive. If an author or publisher starts an Open Universe for one of their hooks, any author can tag one of their books as being a part of this Open Universe, although it must not be for profit: the book must be free, and not supported by advertising/sponsorship. The author or publisher who starts a universe from one of their books is able to remove any book from their Open Universe (for instance if it is offensive or not actually connected to their books), and is able to add and remove moderators, same as for an Official Universe.

A book can have an Official Universe, an Open Universe, or both, and can be connected to several universes in the case of crossovers. Any Universes a book is part of are listed on its page on the Whampa store. By making full use of literary universes, an author or publisher can make finding more of their books easier, as well as encouraging a thriving fan community.

An Official Universe is a collection of books authorized by their owners as part of a connected fictional world.

Every Universe, Open or Official, has a “seed book”, a primary title whose publisher or author becomes the owner of the newly made Universe. To create anew Official Universe, information such as “Universe Name”, “Public information”, “Private information” “Books in Universe” list, w, “Moderators” list, “Accept requests to join”, etc. may be entered.

The “Universe Name” will be how the Universe appears both in your Literary Universe Options listing, and how it appears on the books' Whampa store pages, so pick something that reflects the world. The “Public information” field will be visible to anyone viewing the Universe's page on Whampa store and should give readers information about the books and world, while “Private information” is only seen by authors and publishers with books in the Universe, and is useful for outlining any rules or agreements that being part of the Universe comes with. The “Books in Universe” listing shows all books currently part of your Official Universe. More books may be added. The “Moderators” listing shows Whampa members with moderator status of your Official Universe. More people may be added.

The “Accept requests to join” dictates whether other authors or publishers can request their book be added to your Official Universe. If yes, an author or publisher can request to join, which will send an email to you asking if you wish to accept or decline. No means the only way for books to be added to your Official Universe is for you to actively invite them.

It is possible to add any book to another Literary Universe, either yours or someone else's, Official or Open, or at least request it.

An Open Universe is an open world based upon a book or books and set up by the titles' author or publisher. It has core, official titles, which are the official books in the series or world, and then any other author can tag their own book as being an unofficial part of that world, so long as the book is not for profit (free and not supported by advertising/sponsorship). This allows fans on a book to easily find and connect with fan-fiction writers and their work, building a community around your book(s).

Any paid or advertising supported titles that you add this way will be automatically listed as official (essentially canon, usually written by the author of the primary book). Any non-profit books added this way will open a popup asking if the book should be classed as official canon or not.

B. Creating a Collaborative eBook

In step 912, collaboration features and author's rights are set. Although, in the exemplary implementation described here the collaboration tool is a separate tool from Whampa Writer, the present invention contemplates any separate, combined, integrated, or merged implementation of the writer and collaboration functionalities.

Authors have been working on writing projects together for as long as there has been writing, and this comes with a mix of risks and rewards. Working on a book together inspires and motivates, and two or more authors together can potentially build a complete, vast world and extended series more quickly than one person working alone.

However, there are risks. One person can become bored and quit, trust is required to be confident your compatriots don't steal your work, and rights management can be a pain. While the Whampa Collaboration Tool cannot completely negate these risks, it does provide openness and accountability in a way that also makes the writing process easier.

The first stage is for one author to start a new collaboration project. This is done by opening the collaboration tool and simply selecting create new project. This will open a new manuscript, initially called New Project, into which the author can upload a document, paste in any existing text, or simply start to write. Options such as “Permissions”, “Ownership”, and “Publication” must be set.

The person who starts a new project is the project's owner to start. Once the project exists, you are able to invite collaborators. What permissions each collaborator has will depend on the level of trust between the different parties and what role everyone is expecting to play. Some collaborators, such as paid editors, might have editing permissions for a week or two before having them removed. Others, like beta readers, might be invited so they can read the work and give feedback, but have no permissions to change anything. The rights of different collaborators are flexible and can be changed at any time.

Collaborators may be added, with different permissions set for each collaborator.

Such permissions may include: Add and delete own text/images, Delete others' text/images, Edit metadata, Moderator privileges, etc. “Add and delete own text/images” allows a collaborator to add text and images to the project, and delete anything they personally have added. This does allow a collaborator to type into the middle of someone else's work, but not delete or overwrite it. “Delete others' text/images” gives the freedom to delete text and images, regardless of which contributor entered them. “Edit metadata” allows a collaborator to make changes to title, genre, description, etc. “Moderator privileges” allows the collaborator to add others and amended permissions. By default, a newly added collaborator will have “Add and delete own text/images” set to yes, and all other options set to no.

The rights agreement decides who owns the rights to the manuscript, and in what percentages. This is typically used for agreeing profit share on completed work, ability to sell foreign or film rights, etc. The rights agreement for a collaborative project is a written, legal agreement. There have always been and always will be risks associated with putting time and effort into a creative project with another person, and Whampa cannot accept responsibility should one of the parties, for instance, attempt to sell or solo-publish the completed work. However, the written agreement acts as a deterrent for unscrupulous conduct, and may help in the event of legal action.

When a new project is started, the initial rights agreement is that the owner and initial creator of the project owns 100% of the work. When you add collaborators, they are not automatically granted any ownership of the work. This allows collaborators to either volunteer their input, or for the owner of the project to “trial” a new collaborator before giving up partial ownership of the work.

Click “Add owner” to add a collaborator to this will. This will pull up a list of everyone who is a current collaborator on the project but not already an owner. Double click their name to add then to the owner list. They will appear with 0% ownership. To change the rights, amend the percentage amounts in the left column and click update (an error will come up if the amounts do not total 100%). If you currently own 100% of the project, doing this will immediately change to ownership percentages.

It is very important to note that ownership changes are permanent and that, once a collaborator has been given partial ownership, even 1%, they cannot have this removed or changed without agreement. This is to prevent someone starting a new project, giving 50% ownership, completing the project, and then cutting their co-author out of all rights to the project.

As soon as a project has more than one owner, attempting the change the rights, either adding or removing someone or changing the percentage each owner is entitled to, is no longer instant. Changing the rights will send an email to every other owner than the person attempting to make the change, with a list of the previous rights agreement, the proposed new agreement, and a link to click to agree to the change.

All owners must agree for a change to be made. Any owner can request a change.

C. Export eBook

In step 912, the eBook is exported for publication. At any point, the project can be exported into downloadable files in .doc, .docx, .rtf, .pdf, .odf, etc., format. This file can be given to an external editor, beta readers, or for reading and working offline. Likewise, an EPUB converter is included for turning the completed eBook into an EPUB file for publication.

### D. Additional Functions

Particularly at the beginning of a project, one or more authors may have work already written that will act as the seed of a new collaborative project. Any doc, .docx, .rtf, .txt, .odf file can be uploaded to the project, and its contents will be added to the project manuscript,

Accidents happen. Someone can click overwrite instead of append, upload a file only to find ifs corrupted and contains only gibberish, or accidentally delete huge sections of text. As a result, the Whampa Collaboration tool automatically keeps backups of previous versions.

Tools may be provided for creating and managing serials. In order to set up a new serial, a new profile is created and the options for the new serial are set. The options may include information such as such as genre, secondary genre, description, maturity rating, monetization type, website, sponsorship options, paid options, literary universe options, content management options, etc. The serial's title, genre, secondary genre if applicable, description, maturity rating, website address if applicable, cover art and membership of any literary universes will be viewable on the serial's page on the Whampa store.

The Monetization Type dropdown box may include options such as free, sponsored, paid. With a free serial, readers can view and download the content for free, and without advertising. With a sponsored serial, your content is still free, but contains advertising to support the work. With a paid serial, readers pay a monthly subscription to see the content. Both sponsored and paid subscriptions may have further options of their own.

The cover art of the serial may also be uploaded. The cover will act as the thumbnail and feature image for the serial on the Whampa store. A sample of the serial may also be uploaded. This will be viewable through the store page without subscribing to the serial. To upload cover art or a sample, click the Upload Cover Art or Upload Sample button, which will open a browsing window. Find the file on your computer, and click upload.

With a paid serial, readers pay a monthly subscription to see the content. To help readers feel confident they won't be taken advantage of, and so more likely to subscribe to your serial, Whampa may include a commitment system. Information for the commitment system may include monthly fee, expected average chapter length, expected chapters per month, minimum chapter length, minimum chapters per month, etc.

The monthly fee is the amount charged to each reader per month, in US dollars, with a minimum of $1. Expected chapter length and number of chapters per month is what the author may reasonably expect to be able to produce in an average month. Minimum chapter length and number of chapters is the author's commitment—the number of chapters promised to be produced per month. The expected figures give the reader an idea of what to expect, while the minimum gives them a guarantee—if the author falls below the commitment, the subscribers will not be charged for that month, and you will receive no payment for it.

The expected numbers cannot be lower than the minimum numbers. They can be set the same, but it is often a good idea to set the minimum numbers slightly lower. For instance, if you typically write a chapter a week, so four a month, and they're approx. 2500 words, set that as your expected, and reduce your minimum to three, 1500 word chapters a month. This gives room for both a crisis, and for some variance in chapter length.

While you can set your minimum to one, one-word chapter per month, you are essentially telling your potential subscribers that you intend to take their money even if you do (effectively) nothing in a month, which may put off the majority of readers,

You can change your expected chapter length and chapters per month at any time. You can change your minimum chapter length and chapters per month, however this will only be effective at the beginning of the next moth (minimum of one week), and send an email to any existing subscribers to inform them of the change.

Subscribers are charged at the beginning of each month. For the duration of that month, you can see how much your serial has brought in, but the money cannot be accessed. This is because, should you not meet your commitment level (post less than your minimum chapters per month of your minimum chapter length), then their payment will be rolled over to pay for the next month or, if they choose to unsubscribe, refunded.

Following a month where you have met your commitment, you will be able to withdraw payment for that month.

With a sponsored serial, the content is still free, but contains advertising to support you and your work. There are two main kinds of advertising: banner ads and sponsored text. Banner ads are quicker and easier to set up, but sponsored text can be a less intrusive way of supporting your serial.

Banner adverts are selected based on the genre and maturity level of your serial, so be certain that these accurately reflect your serial (this can be found under the serial's main options). However, you have control over how many appear, when, and where, and can exclude certain types of advertising. Whampa Reader will then insert the best-paying adverts that meet your criteria.

The Banned Topics dropdown box allows you to specify specific topics you would find inappropriate to be advertised alongside your serial. These may include religious, financial products, gambling, political campaigns, and erotic content, among others. Selecting one of these options will produce another identical dropdown box underneath to allow you to add other banned topics.

The Child-friendly Only option is designed for any serial where you expect a young audience, and covers many of these banned topics automatically. Selecting this will automatically ban the topics of erotic content, gambling, drugs/tobacco/alcohol, and violent content, as well as any banner adverts featuring nudity, gore or cursing, regardless of the topic of what it is advertising.

The default options are start and end for frequency, child-friendly only, with no banned subjects.

This varies. Advertising space on Whampa Reader is sold on an auction basis, and the software will always insert the best-paying advertising that meets your criteria. As such, the more restricted the criteria, the lower the advertising revenue (as the software has fewer adverts to choose from).

Any new serial, be it free, sponsored or paid subscription, must have at least one chapter uploaded before it can be published on the Whampa store, although you can also upload more than that, if you for instance want to include a pre-published backlog. New content can be uploaded to the serial and existing content can be amended at any time.

### E. Sponsored Text

Sponsored text allows the sale of product placement within an eBook or serial. For instance, if a character drives a car, visits a store, has a preferred drink etc., the default text (whiskey and cola) can be replaced with a sponsored version (Jack Daniels and Coke). You can have multiple different items available in your book for sponsorship.

To include sponsored text, a new sponsored text profile is created. Sponsored text options may include title, description, setting, minimum bid (per 100), minimum term, type, etc.

The title and description fields are the first things a prospective sponsor will see of the book and available product placement, for instance “Main character's car in establish YA franchise”. This may be followed by a brief description of such things as the circulation of the book, past sales figures, expected audience (is it focused toward males or females, etc.), as well as how highly it features (just turns up to college in it, or is it featured in a chase scene or other situation that would draw attention) and type of vehicle (if the default version of your story has your main character driving a battered jeep, then a Ford truck might be an acceptable sponsor vehicle, but Lexus cabriolet would be unsuitable for your working class character). The sponsor will be able to view the synopsis of the story, genre etc., the same as a person viewing the book's sale page on the Whampa store would be able to.

The Minimum Bid (per 100) field is for the minimum amount that would be accepted per 100 complete viewings of the book, for that particular product placement. This can be left blank and to see what offers are received. Minimum Term is the minimum amount of time that for a sponsor to commit to placement in your book (this is avoid it changing constantly, which can be a little disorienting for readers). The drop down box beside this field decides the units (weeks, months, or years). Type is the kind of product the placement is for. The initial dropdown box covers basic categories, such as vehicles, food and drink, books, restaurants, retail outlets, etc. Any category with sub-categories will produce another dropdown box beneath it. You do not need to go all the way down the chain to the most specific tier, but it can help sponsors find you,

Examples of sponsored text product placements may include:
The main character's favorite drink is a whiskey and cola, which he's seen ordering several times in the book. Branding it to a favorite whiskey as part of that would go under type Food and drink>Alcoholic drinks>Whiskey.
A science fiction novel might include apiece of electronics that doesn't currently exist, such as bionic eyes, but could still be branded by any high-level computer brand as something they might have developed by 2104. This would be listed under type Electronics>Computing>Other.

In order to including sponsored text in a manuscript, the text of the manuscript is searched to find occurrences of the item (product, location, brand name etc.) within the manuscript. If the sponsored word may replace an existing word in the default version of the book (e.g. Jeep to be replaced with Ford), or the sponsored word may be an insertion (e.g. adding a manufacturer's name in front of occasional references to a character's phone). The replaced text or insertion point may be tagged, which marks the spot as a place where a reference to the sponsored item would go. Options that vary based in the type of item may be set, for example, a car may offer make and model.

When making a new profile, if you are not confident you will get a product sponsorship offer you are happy with, it can be a good idea to simply tag positions, rather than completely identify each sponsored word. This makes the process faster, and potential sponsors can still see where their brand would appear. Note however that the manuscript does need to be fully “marked up” before the sponsorship can go live, if you accept an offer.

### F. Banner Ads

Banner adverts are selected based on the genre and maturity level of the content. There is control over how many appear and where, and certain types of advertising can be excluded. Whampa Reader may then insert the best-paying adverts that meet your criteria. Options may include banned topics. Child-friendly Only tick box, “Banner advert every (blank field) words,” etc.

For a completed :Book, rather than a serial, the “Banner advert every (blank field) words” field is what decides the positioning of banner adverts. Whampa reader will then insert one banner ad at the beginning of the novel, and one into the next line break after your selected number of words, e.g. you select one advert per 1000 words. The 1000th word is in the middle of a paragraph, so the next banner advert will be inserted between that paragraph and the next, same for the 2000th word, and so on.

For a serial, rather than a single option, there may be a frequency option, which offers the options of start only, end only, start and end, and every X words. Start only will place an advert at the top of each chapter/episode and new post, end only will place one at the bottom, and start and end will place once banner advert at the top and one at the bottom. Selecting every X words will open the text field next to the frequency dropdown box, for setting how often (every how-many-words) a banner ad will appear. Whampa reader will then insert one banner ad at the beginning, and one into the next line break after your selected number of words, e.g. you select one advert per 1000 words. The 1000th word is in the middle of a paragraph, so the next banner advert will be inserted between that paragraph and the next, same for the 2000th word, and so on

The Banned Topics dropdown box allows setting of specific topics that are inappropriate to be advertised alongside the serial. These may include religious, financial products, gambling, political campaigns, and erotic content, among others. The Child-friendly Only option is designed for any serial a young audience is expected, and covers many of the banned topics automatically. Selecting this will automatically ban the topics of erotic content, gambling, drugs/tobacco/alcohol, and violent content, as well as any banner adverts featuring nudity, gore or cursing, regardless of the topic of what it is advertising,

For a completed eBook, typical default options are one banner advert every 2000 words, child-friendly only, and no banned subjects. For serials, the default options are start and end for frequency, child-friendly only, and no banned subjects.

### III. Dynamic Text Examples

Examples of the creation of Dynamic Text, using, for example, Whampa Writer according to an Embodiment of the Present Invention are described below. The cases shown are merely examples, the present invention contemplates implementation on any current or future hardware or software platform,

The process 1000 of Dynamic Text creation is best understood with reference to FIG. 10. For example, assume the following text from Casino Royale by Ian Fleming:
While they followed the coast road in the direction of Les Noctambules Bond described to her his wild chase in the Bentley, finally pointing out the curve he had taken before the crash and the exact place where the vicious carpet of spikes had been laid. He slowed the car down and leant out to show her the deep cuts in the tarmac made by the rims of the wheels and the broken branches in the hedge and the patch of oil where the car had come to rest.
But all the time she was distrait and fidgety and commented only in monosyllables. Once or twice he caught her glancing in the driving-mirror, but when he had a chance to look hack through the rear window, they had just rounded a bend and he could see nothing

In order to make the Bentley a potential advertising product, in step 1002 the author would highlight the word (or group of words). In step 1004, the advertising zone wizard is activated. The wizard walks through filling out details about this object—either choosing from a list of objects already used inside the book, for continuity, or creating a new one. The parameters may include things like—brand name, color, type of object (basically contextual tags that are attached to each placement, to help advertisers filter, and so you don't end up with a Reebok sneaker instead of the Bentley), type of usage (held by character, passive in scenery, etc.). Once the parameters are put in, in step 1006 a shortcode is generated, such as:
[ad product_id=“123” name=“B123” brand=“Bentley Motors” type=“vehicle” description=“High-End Sedan” tags=“rich,expensive,black,classic”]

Then the shortcode is embedded in the text by wrapping it shortcode around the text to be replaced with compatible products:
While they followed the coast road in the direction of Les Noctambules, Bond described to her his wild chase in the [ad name=“B123” brand=“Bentley Motors” type=“vehicie” description=“High-End Sedan” tags=“rich,expensive,black,classic”]Bentley[/ad], finally pointing out the curve he had taken before the crash and the exact place where the vicious carpet of spikes had been laid. He slowed the car down and leant out to show her the deep cuts in the tarmac made by the rims of the wheels and the broken branches in the hedge and the patch of oil where the car had come to rest.
But all the time she was distrait and fidgety and commented only ire monosyllables. Once or twice he caught her glancing in the driving -mirror, but when he had a chance to look back through the rear window, they had just rounded a bend and he could see nothing.

In the absence of ads, the reader would see Bentley, as it was originally written, but if an advertiser takes over this product in the book, all references to it would be automatically replaced with the winning bidder's product.

For creating other types of dynamic content, the process is the same, but a different set of wizards is used, and different parameters may be included:
While they followed the coast road in the direction of Les Noctambules [if month=“12” day=“24” comparison=“AND”]on Christmas Eve[/if]. Bond described to her his wild chase in the Bentley, finally pointing out the curve he had taken before the crash and the exact place where the vicious carpet of spikes had been laid[if latitude=“45.438627” longitude=“4.383822” gps_range=“15 km” comparison=“AND”] (and watch out, dear reader, cause you're driving over them RIGHT NOW!)[/if]. He slowed the car down and leant out to show her the deep cuts in the tarmac made by the rims of the wheels and the broken branches in the hedge and the patch of oil where the car had come to rest.

But all the time she was [if temp=“LESS THAN 0C”]shivering and sneezing[else]distrait and fidgety[/if] and commented only in monosyllables. Once or twice he caught her glancing in the driving-mirror, but when he had a chance to look back through the rear window, they had just rounded a bend and he could see nothing.

If it was desired to make a popup appear with extra information to engage the reader, triggers are created, for example (you can chain multiple events into the same trigger, too):
While the followed the coast road in the direction of [trigger dialog=“2” achievement=“12345”]Les Noctambules[/trigger]. Bond described to her his wild chase in the Bentley, finally pointing out the curve he had taken before the crash and the exact place where the vicious carpet of spikes had been laid. He slowed the car down and leant out to show her the [trigger dialog=“1”] deep cuts in the tarmac[/trigger] made by the rims of the wheels and the broken branches in the hedge and the patch of oil where the car had come to rest.
But all the time she was distrait and fidgety and commented only in monosyllables. Once or twice he caught her glancing in the driving-mirror, but when he had a chance to look back through the rear window, they had just rounded a bend and he could see nothing.

Those dialogs and achievements could be defined anywhere else in the manuscript, for example:
[dialog id=“1”] Content for the “deep cuts in the tarmac” dialog goes here. Perhaps a picture of the accident? [/dialog]
[dialog id=“2”] Content about Les Noctambules—a map? Picture gallery? [trigger item=“5”]Ticket stub[/trigger] from Bond's airline? [/dialog]

Triggers can be put inside dialogs too, for example:
[achievement id=“12345” name=“World Traveler” hits=“5” icon=“3123”] Congrats! You've discovered FIVE unique locations in the story! You're a real World Traveler! [/achievement]
[item id=“5” name=“A Mysterious Ticket Stub” icon=“6244”] Oh, what's this? A ticket stub! Who knows where this will come in handy . . . [/Item]

The shortcodes are not typically displayed to the end user, unless they were in code view. Switching now to an end user reading the text, in step 1008, the original text is displayed. In step 1010, the embedded shortcodes are evaluated to determine which, if any, conditions and/or triggers specified in the shortcodes are satisfied. In step 1012, the original text, alternative text, and/or dynamic text is displayed as appropriate based on the results of the evaluation of the conditions and/or triggers specified in the shortcodes. The process then loops back to step 1010, causing continuous or periodic re-evaluation of the conditions and/or triggers specified in the shortcodes.

An exemplary block diagram of a computing device 1100 in which one or more modules of the Whampa system may be implemented is shown in FIG. 11. Computing device 1100 is typically a programmed general-purpose computing device, such as a personal computer, workstation, server system, and minicomputer or mainframe computer, or a programmed personal device, such as a smartphone or table. Computing device 1100 includes one or more processors (CPUs) 1102A-1102N, input/output circuitry 1104, network adapter 1106, and memory 1108. CPUs 1102A-1102N execute program instructions in order to carry out the functions of the present invention. Typically, CPUs 1102A-1102N are one or more microprocessors, such as an INTEL PENTIUM® processor. FIG. 11 illustrates an embodiment in which computing device 1100 is implemented as a single multi-processor computer system, in which multiple processors 1102A-1102N share system resources, such as memory 1108, input/output circuitry 1104, and network adapter 1106. However, the present invention also contemplates embodiments in which computing device 1100 is implemented as a plurality of networked computer systems, which may be single-processor computer systems, multi-processor computer systems, or a mix thereof.

Input/output circuitry 1104 provides the capability to input data to, or output data from, computing device 1100. For example, input/output circuitry may include input devices, such as keyboards, mice, touchpads, trackballs, scanners, etc., output devices, such as video adapters, monitors, printers, etc., and input/output devices, such as, modems, etc. Network adapter 1106 interfaces device 1100 with a network 1110. Network 1110 may be any public or proprietary LAN or WAN, including, but not limited to the Internet, one or more Wi-Fi networks, Cable data and video networks, FiOS, DSL, Cellular data networks, such 20, 30, 40, and the like, etc.

Memory 1108 stores program instructions that are executed by, and data that are used and processed by, CPU 1102 to perform the functions of computing device 1100. Memory 1108 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (LIDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 1108 varies depending upon the function that computing device 1100 is programmed to perform. In the example shown in FIG. 11, memory contents that would be included in a user device or in a server/backend system are shown. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 11, memory 1108 includes Whampa Reader 102, Whampa Writer 104, Whampa Market 106, Whampa Social 108, Whampa Gaming 110, Whampa Finance 112, Whampa Film 114, Whampa Audio 116, Whampa EDU 118, Whampa Cares 120, Whampa Change 122, Whampa Projects 124 and operating system 1120. In the case where computing device 1100 is a user device, modules 102-124 implement the user interface and user functionality for each component in the case where computing device 1100 is a server or backend system, modules 102-124 implement the server-side or backend functionality for each component.

In either the user or server/backend case, Whampa Reader 102 includes software for implementing a digital eBook market and integrated reading environment accessible via the web browser and as native Android, iOS, and Windows Phone/RT 8 applications. Whampa Writer 104 includes software for implementing a suite of e-publishing tools enabling authors to create, collaborate, market, and oversee all aspects of their publishing journey Whampa Market 106 includes software for implementing a crowdsourcing platform enabling users to complement their limited abilities and knowledge with those of others, leading to better, more marketable books and other digital products. Whampa Social 108 includes software for implementing a layer of social networking features facilitating in-book communication, sharing, event management, as well as virtual gifting of items, maintaining of robust avatar profiles, inventory, achievements, and more. Whampa Gaming 110 includes software for implementing a MMO gaming environment connected to the Whampa universe, integrating with the achievements and avatar system of Whampa Social. Whampa Finance 112 includes software for implementing a crowdfunding engine to help authors and other participants to finance projects based on demand. Whampa Film 114 includes software for implementing a social marketplace aimed at facilitating the production of trailers, movie treatments, Whampa Finance-based crowdfunding for film projects, and other tools for helping bring authors' words to the silver screen. Whampa Audio 116 includes software for implementing the audiobook and music counterpart to Whampa Film, assisting participants with the coordination, financing, and production of everything audio. Whampa EDU 118 includes software for implementing a layer of academic tools to help enhance the eBook experience in the classroom and outside of it. Students can form study groups, teachers can add gradeable quizzes right into their students' eBooks, and more, Whampa Cares 120 includes software for implementing all of Whampa's spokes will donate 10% of profits to charity as a rule, but here participants can drum up support for their own causes, and the charities themselves can compete for donations. Whampa Change 122 includes software for implementing a platform for political and social change based on crowd-based demand, support, and engagement. Applicable to politics, social matters, or anyone in need of a soapbox or donations. Whampa Projects 124 includes software for implementing robust project management and workflow system to help content creators (especially publishers) manage their staff, release schedules, hired consultants, and marketing assets all from one place.

As shown in FIG. 11, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two,

It is important to note that while aspects of the present invention have been described in the context of a fully functioning data processing system, those of ordinary skill in the art will appreciate that the processes of the present invention are capable of being distributed in the form of a computer program product including a computer readable medium of instructions. Examples of non-transitory computer readable media include storage media, examples of which include, but are not limited to, floppy disks, hard disk drives, CD-ROMs, DVD-ROMs, RAM, and, flash memory.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. Indeed, many modifications and variations are possible in light of the above teaching. For example, elements and components described herein may be further divided into additional components or joined together to form fewer components for performing the same functions.

1. An electronic book reader comprising:
a visual display;
a processor configured to execute program instructions;
a memory storing the program instructions to be executed by the processor;
program instructions to be executed by the processor; and
at least one content piece comprising a plurality of text, the text including at least one item of information fir controlling dynamic display of text;
wherein the program instructions are configured to perform, when executed by the processor:
evaluating the at least one item of information for controlling dynamic display of text; and
displaying, on the visual display, text based on the evaluation of the at least one item of information for controlling dynamic display of text.

2. The electronic book reader of claim 1, wherein the program instructions further perform:
continuously or periodically re-evaluating the at least one item of information for controlling dynamic display of text.

3. The electronic book reader of claim 1, wherein the information for controlling dynamic display of text comprises at least one of a time-based condition or an action-based trigger.

4. The electronic book reader of claim 3, wherein the time-based condition comprises at least one of a start date, an end date, a start time, an end time, a start moon phase, an end moon phase, a start weekday, or an end weekday.

5. The electronic book reader of claim 3, wherein the action-based condition comprises at least one of a view page number, a completed survey/quiz, or a completed scavenger hunt.

6. The electronic book reader of claim 1, wherein at least some of the text that is displayed based on the evaluation of the at least one item of information for controlling dynamic display of text is advertising content or sponsored content.

7. A method for displaying an electronic book in a system comprising a visual display, a processor configured to execute program instructions, a memory storing the program instructions to be executed by the processor, and program instructions to be executed by the processor and configured to perform, when executed by the processor:
receiving at least one content piece comprising a plurality of text, the text including at least one item of information for controlling dynamic display of text;
evaluating the at least one item of information for controlling dynamic display of text; and
displaying, on the visual display, text based on the evaluation of the at least one item of information for controlling dynamic display of text.

8. The method of claim 7, further comprising:
continuously or periodically re-evaluating the at least one item of information for controlling dynamic display of text.

9. The method of claim 7, wherein the information for controlling dynamic display of text comprises at least one of a time-based condition or an action-based trigger.

10. The method of claim 9, wherein the time-based condition comprises at least one of a start date, an end date, a start time, an end time, a start moon phase, an end moon phase, a start weekday, or an end weekday.

11. The method of claim 9, wherein the action-based condition comprises at least one of a view page number, a completed survey/quiz, or a completed scavenger hunt.

12. The method of claim 7, wherein at least some of the text that is displayed based on the evaluation of the at least one item of information for controlling dynamic display of text is advertising content or sponsored content.

13. A computer program product for displaying an electronic book, the computer program product comprising a non-transitory computer readable medium storing program instructions to be executed by a processor configured to perform, when executed by the processor:
receiving at least one content piece comprising a plurality of text, the text including at least one item of information for controlling dynamic display of text;
evaluating the at least one item of information for controlling dynamic display of text; and
displaying, on a visual display, text based on the evaluation of the at least one item of information for controlling dynamic display of text.

14. The method of claim 13, further comprising:
continuously or periodically re-evaluating the at least one item of information for controlling dynamic display of text.

15. The method of claim 13, wherein the information for controlling dynamic display of text comprises at least one of a time-based condition or an action-based trigger.

16. The method of claim 15, wherein the time-based condition comprises at least one of a start date, an end date, a start time, an end time, a start moon phase, an end moon phase, a start weekday, or an end weekday.

17. The method of claim 15, wherein the action-based condition comprises at least one of a view page number, a completed survey/quiz, or a completed scavenger hunt.

18. The method of claim 13, wherein at least some of the text that is displayed based on the evaluation of the at least one item of information for controlling dynamic display of text is advertising content or sponsored content.

19. An apparatus for generating content for an electronic book reader comprising:
a visual display;
a user input device;
a processor configured to execute program instructions;
a memory storing the program instructions to be executed by the processor;
program instructions to be executed by the processor; and
wherein the program instructions are configured to perform, when executed by the processor:
receiving at least one content piece comprising a plurality of text;
receiving, at the user input device, an indication of at least one item of information for controlling dynamic display of text specifying text that is to be displayed based on evaluation of the at least one item of information, and an indication of a location in the plurality of text;
embedding the indicated at least one item of information for controlling dynamic display of text in the plurality to text at the indicated location.

20. The apparatus of claim 19, wherein the information for controlling dynamic display of text comprises at least one of a time-based condition or an action-based trigger.

21. The electronic book reader of claim 20, wherein the time-based condition comprises at least one of a start date, an end date, a start time, an end time, a start moon phase, an end moon phase, a start weekday, or an end weekday.

22. The electronic book reader of claim 20, wherein the action-based condition comprises at least one of a view page number, a completed survey/quiz, or a completed scavenger hunt.

23. The electronic book reader of claim 19, wherein at least some of the text that is specified to be displayed based on the evaluation of the at least one item of information for controlling dynamic display of text is advertising content or sponsored content.
